(19) United States
(12) Patent Application Publication
(10) Pub. No.: US 2019/0259016 A1
(43) Pub. Date: Aug. 22, 2019

(54) RECEIPT PRINTER AND OPERATION METHOD THEREOF

(71) Applicant: TOSHIBA TEC KABUSHIKI KAISHA, Tokyo (JP)

(72) Inventor: Kazunori KATO, Izu Shizuoka (JP)

(21) Appl. No.: 16/271,394

(22) Filed: Feb. 8, 2019

(30) Foreign Application Priority Data
Feb. 21, 2018 (JP) 2018-028815

(51) Int. Cl. G06Q 20/20; H04N 1/00

(52) U.S. Cl. CPC G06Q 20/209; H04N 1/00233

(57) ABSTRACT

A receipt printer includes a printing device, a communication interface configured to receive transaction data, a first wireless communication module, a second wireless communication module, and a processor. The first wireless communication module is configured to wirelessly receive customer identification data from an external communication terminal carried by a customer. The processor configured to control the printing device to print a receipt image on a receipt sheet based on the transaction data received by the communication interface. The processor is further configured to obtain additional data associated with the customer identification data from a server, the additional data being different form the transaction data, generate receipt data indicative of a receipt image including transaction information corresponding to the transaction data and additional information corresponding to the additional data, and control the second wireless communication module to wirelessly transmit the receipt data.

### CROSS-REFERENCE TO RELATED APPLICATION

This application is based upon and claims the benefit of priority from Japanese Patent Application No. 2018-028815, filed on Feb. 21, 2018, the entire contents of which are incorporated herein by reference.

### FIELD

Embodiments described herein relate generally to a receipt printer and an operation method thereof.

### BACKGROUND

In addition to information such as a list of commodities and transaction result relating to a transaction, additional information such as advertisement may be printed on a receipt.

However, contents of the additional information may be determined by a receipt issuing side such as a retail store. For this reason, the additional information may not be useful for a user who receives the receipt. Therefore, it is desirable to add information that is more useful for the user to the receipt.

### DESCRIPTION OF THE DRAWINGS

FIG. 1 is a block diagram illustrating a circuit configuration of main portions of a receipt printer according to an embodiment.

FIG. 2 is a diagram illustrating a configuration of a data record included in condition data.

FIG. 3 is a flowchart depicting information processing executed by a processor of the receipt printer in FIG. 1.

FIG. 4 is a flowchart depicting information processing executed by a processor of the receipt printer in FIG. 1.

FIG. 5 is a flowchart depicting information processing executed by a processor of an information terminal in FIG. 1.

FIG. 6 is a diagram illustrating an example of a browsing screen displayed based on electronic receipt data.

FIG. 7 is a diagram illustrating another example of the browsing screen displayed based on the electronic receipt data.

### DETAILED DESCRIPTION

In accordance with an embodiment, a receipt printer includes a printing device, a communication interface configured to receive transaction data, a first wireless communication module, a second wireless communication module, and a processor. The first wireless communication module is configured to wirelessly receive customer identification data from an external communication terminal carried by a customer. The processor configured to control the printing device to print a receipt image on a receipt sheet based on the transaction data received by the communication interface. The processor is further configured to obtain additional data associated with the customer identification data from a server, the additional data being different form the transaction data, generate receipt data indicative of a receipt image including transaction information corresponding to the transaction data and additional information corresponding to the additional data, and control the second wireless communication module to wirelessly transmit the receipt data.

Here, an embodiment is described with reference to the accompanying drawings.

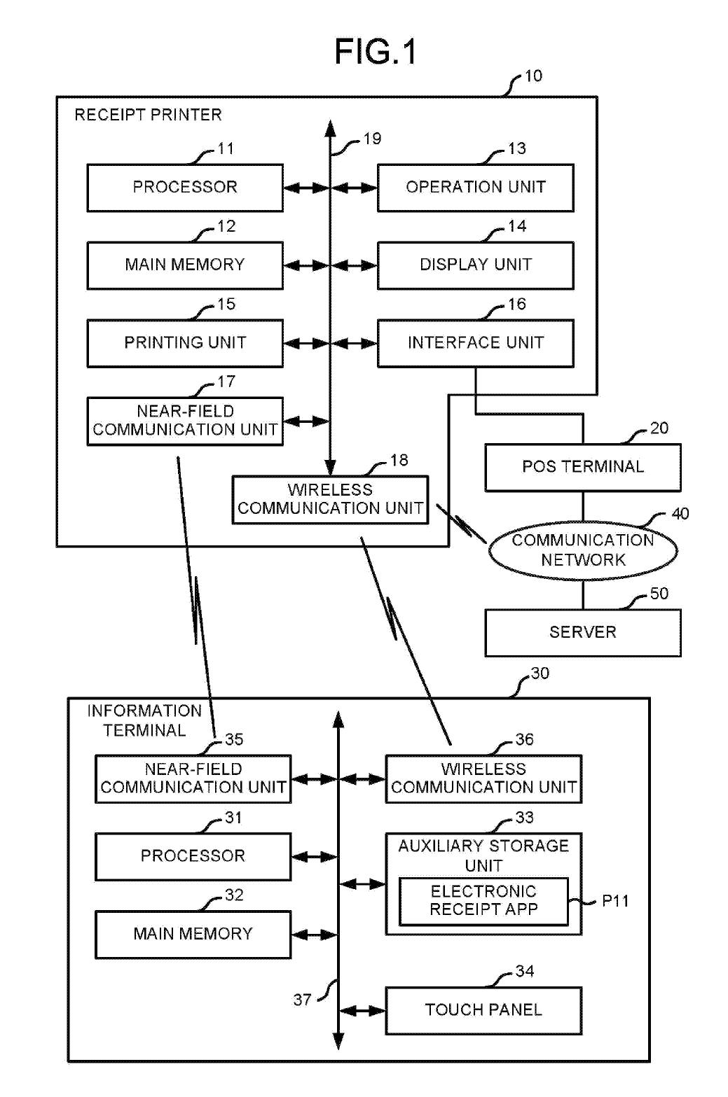

FIG. 1 is a block diagram illustrating a circuit configuration of main portions of a receipt printer 10 according to an embodiment.

The receipt printer 10 is used by being connected to a POS (point-of-sale) terminal 20, and issues a paper receipt in response to a printing request from the POS terminal 20. The receipt printer 10 has a function of transmitting information recorded on the paper receipt as electronic receipt data to an information terminal 30. The receipt printer 10 has a function of adding additional data acquired from a server 50 via a communication network 40 to the electronic receipt data.

The POS terminal 20 may be an existing POS terminal to which the receipt printer 10 is attached externally. The POS terminal 20 of the present embodiment is capable of communicating with the server 50 via the communication network 40 and has a function of transmitting various kinds of information relating to commodity sales to the server 50.

The information terminal 30 is possessed by a user who utilizes a service of transmission of electronic receipt data (hereinafter, referred to as an electronic receipt service) provided by the receipt printer 10. The information terminal 30 is used by the user as a terminal for utilizing the electronic receipt service.

The communication network 40 establishes data communication between various terminals connected to each other such as the receipt printer 10, the POS terminal 20 and the server 50. The communication network 40 may be the Internet, a VPN (virtual private network), a LAN (local area network), a public communication network, a mobile communication network, a dedicated line, etc. or may an appropriate combination of those.

Although a plurality of servers 50 can be connected to the communication network 40, only one server 50 is shown in FIG. 1. When a plurality of servers 50 is connected to the communication network 40, the plurality of servers 50 may be servers of a plurality of different types. A POS server that manages data for commodity sales management, a point server that performs data management for point service or an advertisement server that performs data management for advertisement distribution is provided as an example of the server 50. The server 50 may have those plural functions.

One of the servers 50 stores user database. The user database includes various kinds of information for managing users already registered to utilize the electronic receipt service. The user database includes condition data indicating a condition for adding additional data to the electronic receipt data to be transmitted to the user identified by a user code (customer identification data) in association with the user code for identifying each user.

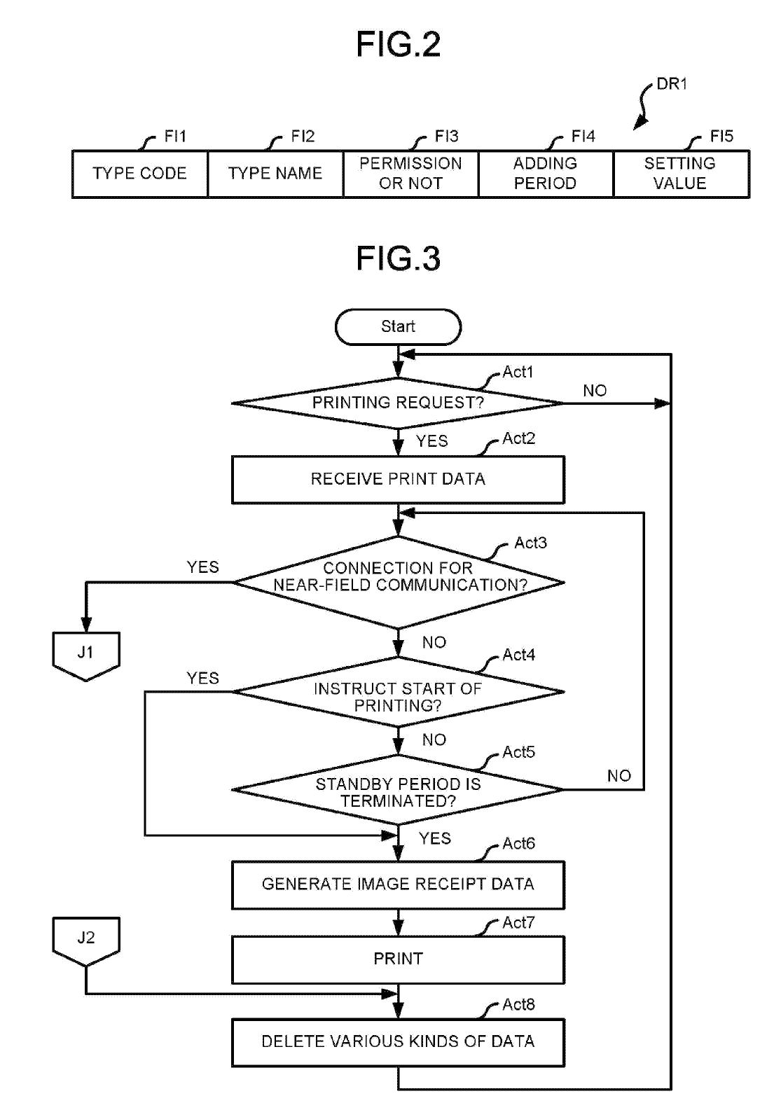

FIG. 2 is a diagram illustrating a configuration of a data record DR1 included in the condition data.

The condition data is a set of a plurality of data records DR1. The plurality of data records DR1 corresponds to the plurality of types of additional data determined as objects to be added to the electronic receipt data according to the electronic receipt service, respectively. The plural types of additional data include, for example, total settlement amount information, point information, coupon information, bargain sale information, etc. For example, the total settlement amount information indicates a difference between a total amount of settlement relating to a user within a period such as the current month and a predetermined target value. The point information indicates a relationship between a point usage amount within a period such as the current month and a predetermined upper limit amount. The coupon information indicates a coupon that can be used by the user. The bargain sale information indicates bargain sale being offered or scheduled to be offered.

The data record DR1 includes fields FI1, FI2, FI3, FI4 and FI5.

In the field FI1, a type code indicating the type of the corresponding additional data is recorded. The type code is predetermined to be capable of identifying each of the plural types of additional data. In the field FI2, a name assigned to the type of the corresponding additional data is recorded. In the field FI3, it is recorded whether to permit the corresponding additional data to be added to the electronic receipt data. In the field FI4, a period during which the corresponding additional data is added to the electronic receipt data is recorded. In the field FI5, an arbitrarily set value included in an addition condition of the corresponding additional data is recorded.

For example, if the information relating to the point service is frequently permitted to be added, and an upper limit is set to “3,000”, in the fields FI1 to FI5, an identification code of the point information, a character string “point information”, a value indicating permission, a value indicating frequent addition, and a numerical value “3,000” are recorded, respectively. For example, if the addition of information relating to the total settlement amount is permitted after six or more hours since the same type of information is added last time, in the fields FI1 to FI5, an identification code of the total settlement amount information, a character string “total settlement amount information”, a value indicating that the addition is permitted in a period excluding a certain period after addition, a numerical value “6” are recorded, respectively.

The server 50 that manages the user database receives the access from the user to update the condition data in response to an instruction from the user.

The receipt printer 10 includes a processor 11, a main memory 12, an operation unit 13, a display unit 14, a printing unit 15, an interface unit 16, a near-field communication unit 17, a wireless communication unit 18, and a transmission path 19. The processor 11, the main memory 12, the operation unit 13, the display unit 14, the printing unit 15, the interface unit 16, the near-field communication unit 17 and the wireless communication unit 18 are connected to each other via the transmission path 19.

In the receipt printer 10, the processor 11 and the main memory 12 are connected to each other via the transmission path 19 to constitute a computer for performing information processing for controlling the receipt printer 10. The receipt printer 10 may further include an auxiliary storage unit connected to the transmission path 19, and in this case, the above computer includes the auxiliary storage unit as an auxiliary storage portion. The auxiliary storage unit may be, for example, an EEPROM (electric erasable programmable read-only memory). The auxiliary storage unit may also be an HDD (hard disc drive) or an SSD (solid state drive).

The processor 11 acts as a central functional module of the computer. The processor 11 controls each module of the computer to perform various functions of the receipt printer by executing an operating system, a firmware, and application programs.

The main memory 12 acts as main memory of the computer. The main memory 12 includes a nonvolatile memory area and a volatile memory area. The main memory 12 stores the operating system, the firmware, and the application programs in a nonvolatile memory area. The main memory 12 may store data necessary for the processor 11 to execute processing to control each unit of the computer in the nonvolatile or volatile memory area. The main memory 12 uses the volatile memory area as a work area where data is appropriately rewritten by the processor 11.

The operation unit 13 inputs an operation performed by an operator. The operation unit 13 may include various operation devices such as a touch panel, a keyboard, a key switch, and the like.

The display unit 14 performs a display for presenting various kinds of information to the operator. The display unit 14 may include various display devices such as a touch panel, an LED (Light Emitting Diode) lamp, a liquid crystal display panel, and the like.

The printing unit 15 can print an image indicating the receipt on the receipt paper.

The interface unit 16 is connected to the POS terminal 20, for example, via a communication cable. The interface unit 16 transmits and receives various kinds of data to and from the POS terminal 20. The interface unit 16 may be an existing device conforming to a well-known standard such as USB (universal serial bus).

The near-field communication unit 17 performs near-field wireless communication with the information terminal 30. The near-field communication unit 17 may be an existing device conforming to a well-known communication standard such as NFC (near field communication).

The wireless communication unit 18 performs wireless communication with the information terminal 30. The wireless communication unit 18 performs data communication via the communication network 40 through wireless communication with a wireless access point included in the communication network 40. The wireless communication unit has a larger communicable distance and a higher communication speed than the near-field communication unit 17. The wireless communication unit 18 may be an existing device conforming to a well-known communication standard such as IEE802.11g.

The transmission path 19 includes an address bus, a data bus, a control signal line, and the like, and transmits data and control signals transmitted and received between the connected units.

The information terminal 30 includes a processor 31, a main memory 32, an auxiliary storage unit 33, a touch panel 34, a near-field communication unit 35, a wireless communication unit 36, and a transmission path 37. The processor 31, the main memory 32, the auxiliary storage unit 33, the touch panel 34, and the wireless communication unit 36 are connected to each other via the transmission path 37.

In the information terminal 30, the processor 31, the main memory 32, and the auxiliary storage unit 33 are connected with each other via a transmission path 37 to constitute a computer that performs information processing for controlling the information terminal 30.

The processor 31 acts as a central functional module of the computer. The processor 31 controls each module of the computer to perform various functions of the information terminal 30 by executing an operating system, a firmware, and application programs.

The main memory 32 acts as main memory of the computer. The main memory 32 includes a nonvolatile memory area and a volatile memory area. The main memory 32 stores the operating system, the firmware, and the application programs in a nonvolatile memory area. The main memory 32 may store data necessary for the processor 31 to execute processing to control each module of the computer in the nonvolatile or volatile memory area. The main memory 32 uses the volatile memory area as a work area where data is appropriately rewritten by the processor 31.

The auxiliary storage unit 33 acts as auxiliary storage of the computer. The auxiliary storage unit 33 is, for example, an EEPROM. The auxiliary storage unit 33 may also be an HDD, an SSD, or the like. The auxiliary storage unit 33 stores data used by the processor 31 to perform various processing and data generated in a processing executed by the processor 31. The auxiliary storage unit 33 stores the application programs.

One of the application programs stored in the auxiliary storage unit 33 is an information processing program P11 (hereinafter, referred to as an electronic receipt application) for executing information processing for using an electronic receipt service including an operation described below in cooperation with the receipt printer 10. Typically, however, the electronic receipt application P11 is downloaded via, for example, the Internet and then written to the auxiliary storage unit 33 in response to an operation performed by a user of the information terminal 30. In other words, the information terminal 30 is accessed by the user of the information terminal 30 in a state in which the electronic receipt application P11 is not stored in the auxiliary storage unit 33. However, the information terminal 30 may be accessed by the user of the information terminal 30 in a state in which the electronic receipt application P11 is stored in the auxiliary storage unit 33 or the main memory 32.

The touch panel 34 functions as an input device and a display device of the information terminal 30.

The near-field communication unit 35 performs wireless communication with the near-field communication unit 17 within a communication range of the near-field communication unit 17. The near-field communication unit 35 may be, for example, an existing device conforming to the same communication standard as the near-field communication unit 17.

When the wireless communication unit 36 is positioned within the communication range of the wireless communication unit 18, the wireless communication unit 36 performs wireless communication with the wireless communication unit 18. The wireless communication unit 36 may be, for example, an existing device conforming to the same communication standard as the wireless communication unit 18.

The transmission path 37 includes an address bus, a data bus, a control signal line, and the like, and transmits data and control signals transmitted and received between the connected units.

The information terminal 30 may be a portable-type information processing apparatus that a user can bring to a retail store, such as a smartphone or a tablet terminal.

The operation of the receipt printer 10 configured as described above is described below together with the relating operation of the information terminal 30.

When the receipt printer 10 is in an operation state in which a receipt is issued in response to a request from the POS terminal 20, the processor 11 executes the following information processing by executing the firmware or the application programs stored in the main memory 12.

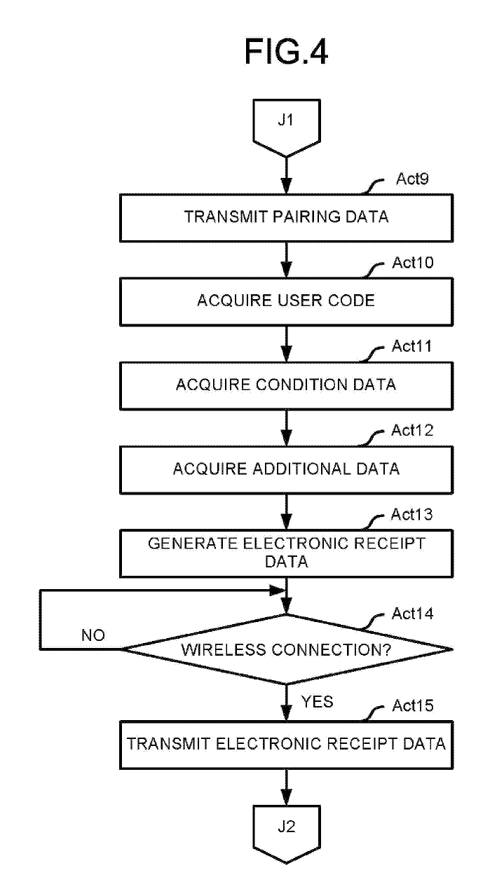

FIG. 3 and FIG. 4 are flowcharts depicting information processing executed by the processor 11.

In Act 1, the processor 11 stands by until a printing request is received from the POS terminal 20. Then, if a printing request is issued from the POS terminal 20, the processor 11 determines Yes and the process proceeds to Act 2.

In Act 2, the processor 11 receives print data transmitted from the POS terminal 20 using the interface unit 16. The print data includes text data and image data respectively indicating a character string and an image required to be shown on the receipt. The character string required to be shown on the receipt may include a store name, a store location, a store phone number, a transaction date and time, a commodity name, a unit price, a discount amount, a total amount, a consumption tax amount, a quantity of commodities, a settlement method and the like. The image indicated by the image data may include an image contained in a receipt, such as a store logo, an advertisement, or the like. The print data may include any text data and any image data. The processor 11 stores the received print data in the main memory 12. As described above, the print data indicates contents of a transaction. In other words, the print data is an example of transaction data indicating the contents of the transaction. By executing the information processing shown in FIG. 3 and FIG. 4 by the processor 11, the computer having the processor 11 as the central functional module functions as a first acquisition module in cooperation with the interface unit 16.

In Act 3, the processor 11 determines whether or not a connection for near-field wireless communication by the near-field communication unit 17 is established. Then, if the connection is not established, the processor 11 determines No, and the process proceeds to Act 4.

In Act 4, the processor 11 determines whether or not the start of printing is instructed. Then, if the start of printing is not instructed, the processor 11 determines No, and the process proceeds to Act 5.

In Act 5, the processor 11 determines whether or not a standby period ends. The processor 11 sets a period until a predetermined standby time elapses from a predetermined timing such as a time point at which the printing request is received or a time point at which reception of the print data is completed as the standby period. The start timing and standby time of the standby period may be arbitrarily determined by a creator of the firmware or the application program relating to the information processing shown in FIG. 3. Then, if the standby period has not ended, the processor 11 determines No, and the process returns to Act 3.

Thus, In Act 3 to Act 5, the processor 11 stands by until the connection for near-field wireless communication is made or the start of printing is instructed before the standby period ends.

A store clerk who operates the POS terminal 20 determines whether a customer wants to issue a paper receipt or utilize the electronic receipt service, and performs a predetermined operation using the operation unit 13 to instruct the start of printing if the customer wants to issue the paper receipt. Then, the processor 11 determines Yes in Act 4 and the process proceeds to Act 6. The operation for instructing the start of printing may be performed using an operation unit provided in the POS terminal 20, and then the instruction is notified from the POS terminal 20 to the processor 11 via the interface unit 16. The operation of instructing the start of printing may be performed by the customer.

If the standby period ends without making a connection for near-field wireless communication or instructing the start of printing, the processor 11 determines Yes in Act 5 and the process proceeds to Act 6.

In Act 6, the processor 11 generates image receipt data including various character strings and images shown in the print data and indicating images to be printed on the receipt paper. The processor 11 stores the generated image receipt data in the main memory 12.

In Act 7, the processor 11 controls the printing unit 15 to print an image based on the image receipt data generated in Act 6 on a receipt paper. By executing the information processing shown in FIG. 3 and FIG. 4 by the processor 11, the computer having the processor 11 as the central functional module functions as a printing module in cooperation with the printing unit 15.

In Act 8, the processor 11 deletes the print data and the image receipt data stored in the main memory 12, respectively. After that, the processor 11 returns to the standby state in Act 1.

If the customer who is a user of the electronic receipt service wants to use the electronic receipt service, the information terminal 30 activates the electronic receipt application P11. By doing this, the processor 31 executes the following information processing by executing the electronic receipt application P11.

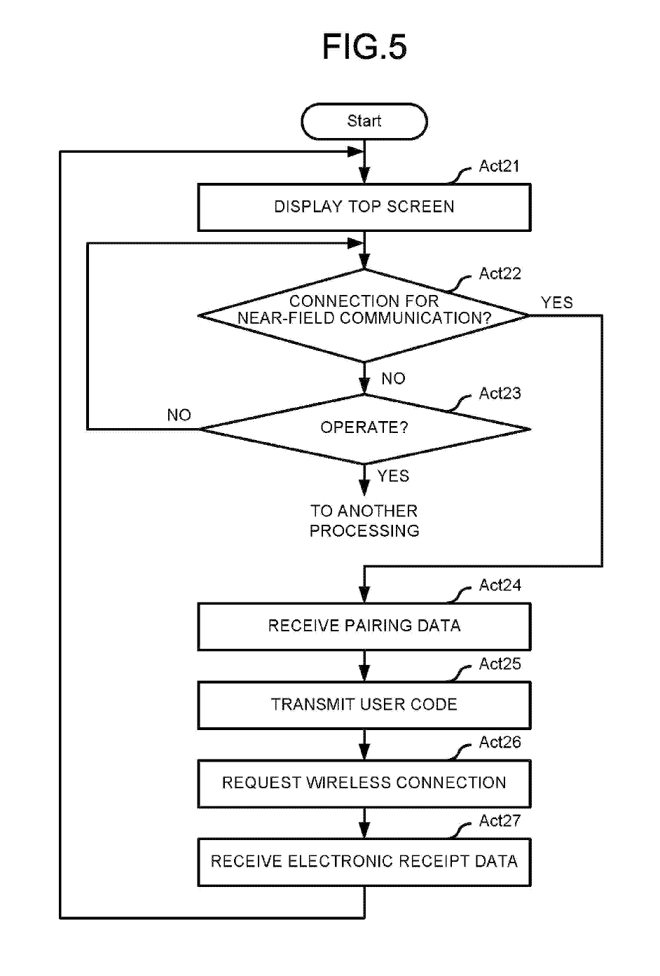

FIG. 5 is a flowchart depicting information processing executed by the processor 31.

In Act 21, the processor 31 displays a top screen on the touch panel 34. The top screen includes a message for guiding to hold the information terminal 30 over the receipt printer 10 to acquire the electronic receipt data. According to the guidance indicated by the message, the user holds the information terminal 30 over the receipt printer 10 in the standby state in Act 3 to Act 5 in FIG. 3. Thus, when the near-field communication unit 35 enters the communication range of the near-field communication unit 17, the mutual connection is established between the near-field communication unit 17 and the near-field communication unit 35. The near-field communication unit 17 and the near-field communication unit 35 respectively notify the processor 11 and the processor 31 that they are connected. If the notification is received, the processor 11 determines Yes in Act 3 in FIG. 3, and the process proceeds to Act 9 in FIG. 4.

In Act 9, the processor 11 transmits pairing data for wireless communication via the wireless communication unit 18 from the near-field communication unit 17. The pairing data is an SSID (service set identifier) and a passphrase if the communication standard to which the wireless communication unit 18 conforms is IEE802.11g.

In the information terminal 30, after displaying the top screen in Act 21 in FIG. 5, the process proceeds to Act 22.

In Act 22, the processor 31 determines whether or not the connection for near-field wireless communication by the near-field communication unit 35 is established. Then, if the connection is not established, the processor 31 determines No, and the process proceeds to Act 23.

In Act 23, the processor 31 determines whether or not an operation such as an instruction to start browsing the electronic receipt is performed using the touch panel 34, for example. Then, if the corresponding operation is not performed, the processor 31 determines No, and the process returns Act 22.

Thus, the processor 31 stands by until the connection for near-field wireless communication is established in Act 22 or the operation is performed in Act 23.

If the processor 31 is notified from the near-field communication unit 35 that the connection is established as described above, the processor 31 determines Yes in Act 22 in FIG. 5 and the process proceeds to Act 24.

In Act 24, the processor 31 receives the pairing data. Specifically, if the pairing data transmitted from the near field communication unit 17 is received by the near-field communication unit 35 as described above, the processor 31 stores the pairing data in the main memory 32 or the auxiliary storage unit 33.

In Act 25, the processor 31 transmits a user code from the near-field communication unit 35. The user code which is assigned to a user when the user is registered is acquired by the processor 31 in response to an input operation performed by the user and is then stored in the main memory 32 or the auxiliary storage unit 33. Then, the processor 31 transmits the stored user code.

In Act 10 in FIG. 4, the processor 11 acquires the user code. Specifically, when the user code transmitted from the near-field communication unit 35 is received by the near-field communication unit 17 as described above, the processor 11 stores the user code in the main memory 12.

In Act 11, the processor 11 acquires condition data associated with the acquired user code from the server 50.

In Act 12, the processor 11 acquires the additional data satisfying a condition indicated by the acquired condition data. Specifically, the processor 11 extracts a data record DR1 in which permission of addition of the additional data to the electronic receipt data is recorded in the field FI3, and a period including the current time point is recorded in the field FI4 as a period in which the additional data is added from the data records DR1 included in the condition data. Here, there is a case in which no data record DR1 can be extracted. In that case, the processor 11 does not perform the processing described below. The processor 11 acquires, from the server 50, predetermined data relating to the additional data having the type identified by the type code recorded in the field FI1 in the extracted data record DR1. The processor 11 may directly use the acquired data as the additional data, or use data obtained by performing predetermined processing on the acquired data as the additional data. For example, if the type identified by the type code is “bargain sale information”, and the text data indicating the character string “next time, the day when the point is doubled is X month X day.” is obtained from the server 50, the text data is used as the additional data without any change. For example, if the type identified by the type code is “total settlement amount information” and data indicating “47,000 Yen” is obtained from the server 50, for example, the processor 11 calculates a difference amount between the data indicating “47,000 Yen” and “50,000 Yen” which is shown as an upper limit amount in the field FI5 of the corresponding data record DR1, and generates text data indicating character strings “to setting amount 3,000 Yen” and “about to reach the upper limit” as the additional data. Here, any processing may be performed by the processor 11, and the processing performed by the processor 11 is predetermined by, for example, the creator of the firmware or the application program for executing the information processing shown in FIG. 3 and FIG. 4.

In Act 13, the processor 11 generates the electronic receipt data based on the print data acquired in Act 2 and the additional data acquired in Act 12. The electronic receipt data is used for displaying a browsing screen of the electronic receipt on the information terminal 30 by the processor 31 executing a processing based on the electronic receipt application P11. The processor 11 stores the generated electronic receipt data in the main memory 12. In this manner, the processor 11 selects the type of the additional data according to the condition indicated by the condition data, and acquires the additional data corresponding to the selected type. By executing the information processing shown in FIG. 3 and FIG. 4 by the processor 11, the computer having the processor 11 as the central portion functions as a selection module.

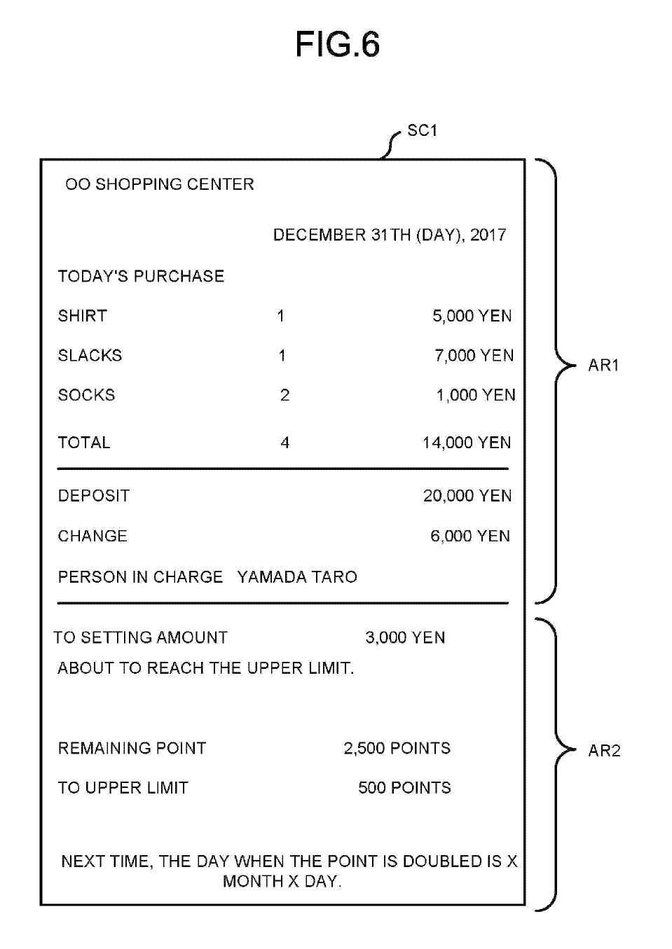

FIG. 6 is a diagram illustrating a browsing screen SC1 as an example screen displayed based on the electronic receipt data.

The browsing screen SC1 includes areas AR1 and AR2. The area AR1 shows contents of the print data. The area AR2 shows the contents of the additional data. The browsing screen SC1 is shown in a case in which the processor 11 acquires the total settlement amount information, the point information, and the bargain sale information in Act 12.

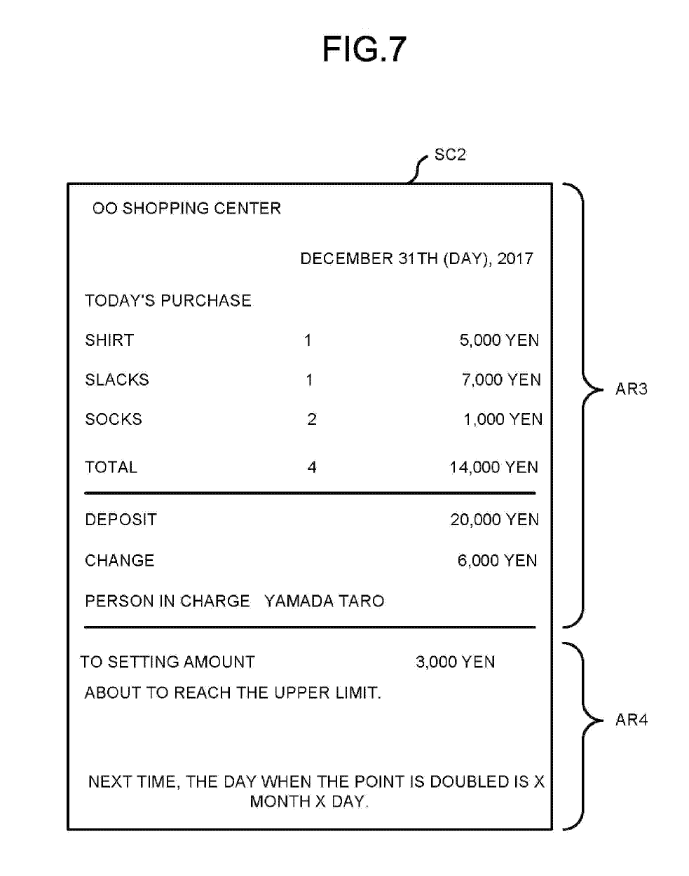

FIG. 7 is a diagram illustrating a browsing screen SC2 as another example screen displayed based on the electronic receipt data.

The browsing screen SC2 includes areas AR3 and AR4. The area AR3 shows the contents of the print data, and is the same as the area AR1 in FIG. 6. The area AR4 indicates the contents of the additional data. The browsing screen SC2 is shown in a case in which the processor 11 acquires the total settlement amount information and the bargain sale information in Act 12.

The processor 11 may generate the electronic receipt data in a text-based data format such as a CSV (comma separated values) format or an HTML (hypertext markup language) format or in an image-based data format such as a bitmap format.

As described above, the electronic receipt data is an example of the receipt data for allowing the user to browse the transaction data and the additional data included in the print data. Thus, by executing the information processing shown in FIG. 3 and FIG. 4 by the processor 11, the computer having the processor 11 as the central functional module functions as a generation module.

On the other hand, at the information terminal 30, if the processor 31 transmits the user code in Act 25, the process proceeds to Act 26.

In Act 26, the processor 31 requests wireless connection using the pairing data received in Act 24 using the wireless communication unit 36.

In the receipt printer 10, if the wireless connection request is received, the wireless communication unit 18 operates to establish a connection for wireless communication with the wireless communication unit 36. Then, if the wireless connection is established, a message indicating the connection is notified to the processor 11.

If the generation of the electronic receipt data is terminated in Act 13 in FIG. 4, the process proceeds to Act 14.

In Act 14, the processor 11 stands by until the wireless connection with the information terminal 30 is established. The processor 11 may start the standby state in parallel with the generation of the electronic receipt data. Then, if it is notified from the wireless communication unit 18 that the wireless connection is established as described above, the processor 11 determines Yes in Act 14 and the process proceeds to Act 15.

In Act 15, the processor 11 transmits the electronic receipt data generated in Act 13 to the wireless communication unit 36 from the wireless communication unit 18 through the above-described wireless connection. The processor 11 may transmit the electronic receipt data after performing a compression processing for reducing data amount on electronic receipt data. The above transmission of the electronic receipt data is an example of the output of the electronic receipt data. Thus, by executing the information processing shown in FIG. 3 and FIG. 4 by the processor 11, the computer having the processor 11 as the central functional module functions as an output module.

If the transmission of the electronic receipt data is completed, the process proceeds to Act 8 in FIG. 3 to execute the processing subsequent to Act 8 in the same manner as described above. In Act 8, the processor 11 deletes all of the print data, the user code, the condition data, the additional data, and the electronic receipt data. The processor 11 deletes the various kinds of data stored in the main memory 12, and then returns to the standby state in Act 1.

If the process proceeds from Act 3 in FIG. 3 to Act 9 in FIG. 4, the processor 11 does not perform printing in Act 7. If the printing is performed in Act 7, the processor 11 does not transmit the electronic receipt data in Act 15.

In the information terminal 30, after requesting the wireless connection in Act 26 in FIG. 5, the process proceeds to Act 27.

In Act 27, the processor 31 receives the electronic receipt data wirelessly transmitted from the receipt printer 10 as described above. Specifically, when the electronic receipt data wirelessly transmitted by the wireless communication unit 18 is received by the wireless communication unit 36, the processor 31 stores the electronic receipt data in the auxiliary storage unit 33.

If the reception of the electronic receipt data is completed, the process returns to Act 21.

If an operation is performed in the standby state in Act 22 and Act 23, the processor 31 determines Yes in Act 23 to execute a processing corresponding to the operation. The operation here includes, for example, an operation of displaying the browsing screen based on the electronic receipt data stored in the auxiliary storage unit 33.

As described above, according to the receipt printer 10, when the electronic receipt data is provided to the information terminal 30 that the user carries, the additional data selected from the plural types of the additional data according to the condition set for the user is added to the electronic receipt data. Therefore, the information useful for the user can be provided to the user through the electronic receipt.

According to the receipt printer 10, a period in which the additional data is added is included in the conditions for selecting the additional data to be added to the electronic receipt data. Therefore, for example, the adding period can be adjusted for the additional data the user wants to add. For example, if the settlement for additional purchase is performed immediately after the user finishes the settlement, there is a possibility that almost the same additional data is repeatedly added to each of the electronic receipt data relating to each settlement. By setting a period since a predetermined time elapses as the adding period for the additional data for which repeated addition as described is unnecessary, it is possible to prevent the repeated addition as described above. It is also possible to add the additional data only to the electronic receipt data relating to the shopping in the daytime.

According to the receipt printer 10, the electronic receipt data is provided to the user at the time of settlement in the retail store. For this reason, the user can receive the electronic receipt data just like reception of the paper receipt. As a result, it is possible to promote use of the electronic receipt service. It is unnecessary to use a server for providing the electronic receipt data to the user, and the electronic receipt data can be provided at a lower cost than that in the case of using a server-type existing electronic receipt system.

Since the receipt printer 10 receives only a request for printing the paper receipt from the POS terminal 20, the POS terminal 20 may be an existing device which does not handle the electronic receipt service without any change. In other words, in the existing POS system, it is possible to provide the electronic receipt service by simply replacing an existing receipt printer with the receipt printer 10 of the present embodiment.

In the near-field wireless communication, the receipt printer 10 transmits and receives the pairing data and the user code, and in the transmission of the electronic receipt data, the wireless communication having a longer communicable distance and higher communication speed than the near-filed wireless communication is used. Therefore, the electronic receipt data can be transmitted to the information terminal 30 away from the receipt printer 10 in a short time. As a result, it is possible to transmit the image receipt data from the receipt printer 10 to the information terminal 30, for example, while the user is bagging purchased commodities. Then, the receipt printer 10 transmits the pairing data to the information terminal 30 together with the text receipt data through the near-field wireless communication. Therefore, there is no need to set the pairing data in the information terminal 30 in advance.

In the present embodiment, the following various modifications can be made.

The electronic receipt data may be transmitted from the receipt printer 10 to the information terminal 30 using the near-field wireless communication.

The condition data may be acquired from any acquisition source. For example, the condition data may be stored in the main memory 12. Alternatively, the processor 11 may determine the condition for selecting the additional data to be added to the receipt for the transaction in response to an instruction for each transaction from the user.

The type of the additional data does not necessarily include the type described in the above embodiment, and may include other types. For example, the advertisement data may be used as one type of the additional data.

The acquisition of the additional data and the generation of the electronic receipt data may be executed by an information processing apparatus capable of communicating with the receipt printer 10. In this case, the processor 11 transmits the print data received in Act 2 and the user code received in Act 10 to the above information processing apparatus, and acquires the electronic receipt data generated by the information processing apparatus.

An image corresponding to the area AR2 shown in FIG. 6 may be generated by the information processing apparatus capable of communicating with the receipt printer 10. Then, the processor 11 may generate an image corresponding to the area AR1 shown in FIG. 6 and combine it with the image generated by the information processing apparatus to generate the electronic receipt data.

The processor 11 may determine whether the paper receipt or the electronic receipt is required to be issued according to an instruction from the user after Act 12, for example. In this case, if it is determined that the electronic receipt is required to be issued, the process proceeds to Act 13. However, if it is determined that the paper receipt is required to be issued, the processor 11 generates the image receipt data including the additional data, and controls the printing unit 15 to print the image receipt data on the receipt paper. In this case, the image receipt data is an example of the receipt data for allowing the user to browse the transaction data and the additional data included in the print data. The above-described printing is an example of the output of the receipt data.

The paper receipt to which the additional data is added may be issued without providing the electronic receipt data. In this case, for example, the process proceeds from Act 2 in FIG. 3 to Act 10 in FIG. 4, and from Act 12 to Act 6. Then, in Act 6, the processor 11 generates image receipt data indicating an image including an image corresponding to the area AR2 shown in FIG. 6, for example.

Both issuance of the paper receipt and transmission of the electronic receipt data may be performed in one transaction.

In a server-type electronic receipt server that provides the electronic receipt service, it is also possible to execute the processing in Act 10 to Act 13. In this case, the electronic receipt server may be a general-purpose information processing apparatus, and it can be realized by enabling a computer of the information processing apparatus to execute an application program relating to the above-described information processing. The application program may be transferred in a state in which it is stored in a storage device of the information processing apparatus, or may be transferred separately from the hardware of the information processing apparatus in a state in which it is stored in any computer-readable storage medium or through communication.

The user code may be acquired by any other methods such as a method of reading it from a magnetic card or an IC card storing the user code or a method of manually inputting it by the user.

A part or all of the functions performed by the processor 11 executing the information processing may be performed by hardware for executing an information processing not based on a program, such as a logic circuit or the like. The above-described functions may also be performed by a combination of the software control with the hardware such as the above-described logic circuit.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A receipt printer comprising:
a printing device;
a communication interface configured to receive transaction data;
a first wireless communication module configured to wirelessly receive customer identification data from an external communication terminal carried by a customer;
a second wireless communication module; and
a processor configured to:
control the printing device to print a receipt image on a receipt sheet based on the transaction data received by the communication interface;
obtain additional data associated with the customer identification data from a server, the additional data being different form the transaction data;
generate receipt data indicative of a receipt image including transaction information corresponding to the transaction data and additional information corresponding to the additional data; and
control the second wireless communication module to wirelessly transmit the receipt data.

2. The receipt printer according to claim 1, wherein the processor controls the second wireless communication module to wirelessly transmit the receipt data to the external communication terminal.

3. The receipt printer according to claim 1, wherein the additional data include promotion data associated with the customer identification data.

4. The receipt printer according to claim 1, wherein the additional data include reward data associated with the customer identification data.

5. The receipt printer according to claim 1, wherein the processor is configured to:
control the printing device to print the receipt image and the second wireless communication module to not wirelessly transmit the receipt data, when no wireless communication with the external communication terminal is established with the second wireless communication module; and
control the printing device to not print the receipt image and the second wireless communication module to wirelessly transmit the receipt data, when a wireless communication with the external communication terminal is established with the second wireless communication module.

6. The receipt printer according to claim 1, wherein a communication range of the second wireless communication module is longer than a communication range of the first wireless communication module.

7. The receipt printer according to claim 1, wherein a communication data rate of the second wireless communication module is faster than a communication data rate of the first wireless communication module.

8. The receipt printer according to claim 1, wherein the processor is further configured to compress the receipt data, and the receipt data transmitted by the second wireless communication module is compressed receipt data.

9. The receipt printer according to claim 1, wherein the processor is further configured to store the receipt data in memory, and delete the receipt data stored in the memory after determining that the receipt image is printed on the receipt sheet.

10. The receipt printer according to claim 1, wherein the processor is further configured to store the receipt data in memory, and delete the receipt data stored in the memory after determining that the wireless communication module transmits the receipt data.

11. An operation method of a receipt printer comprising:
receiving transaction data through a communication interface from a point-of-sale (POS) terminal;
when a wireless connection with an external communication terminal carried by a customer is not established, printing a receipt image on a receipt sheet based on the transaction data received by the communication interface; and
when the wireless connection with the external communication terminal is established,
wirelessly receiving customer identification data from the external communication terminal carried by the customer;
obtaining additional data associated with the customer identification data from a server, the additional data being different form the transaction data;
generating receipt data indicative of a receipt image including transaction information corresponding to the transaction data and additional information corresponding to the additional data; and
wirelessly transmitting the receipt data to the external communication terminal.

12. The operation method according to claim 11, wherein
a first wireless communication protocol is used to receive the customer identification data, and a second wireless communication protocol different from the first wireless communication protocol is used to transmit the receipt data.

13. The operation method according to claim 11, wherein the additional data include promotion data associated with the customer identification data.

14. The operation method according to claim 11, wherein the additional data include reward data associated with the customer identification data.

15. The operation method according to claim 11, wherein a communication range of the second wireless communication module is longer than a communication range of the first wireless communication module.

16. The operation method according to claim 11, wherein a communication data rate of the second wireless communication module is faster than a communication data rate of the first wireless communication module.

17. The operation method according to claim 11, further comprising:
compressing the receipt data, and the transmitted receipt data is the compressed receipt data.

18. The operation method according to claim 11, further comprising:
storing the receipt data in memory; and
deleting the receipt data stored in the memory after determining that the receipt image is printed on the receipt sheet.

19. The operation method according to claim 11, further comprising:
storing the receipt data in memory; and
deleting the receipt data stored in the memory after determining that the receipt data is transmitted.
